(19) United States
(12) Patent Application Publication
(10) Pub. No.: US 2005/0076588 A1
(43) Pub. Date: Apr. 14, 2005

(54) Double-glazed thermoinsulated external wall

(76) Inventor: Massimo Sensini, Cesena (IT)

Correspondence Address: MCGLEW & TUTTLE, PC, 1 SCARBOROUGH STATION PLAZA, SCARBOROUGH, NY, 10510-0827, US

(21) Appl. No.: 10/503,759

(22) PCT Filed: Mar. 21, 2003
(86) PCT No.: PCT/IT03/00167

(30) Foreign Application Priority Data
Apr. 3, 2002 (IT) BO2002A000172

(51) Int. Cl. E06B 9/01

(52) U.S. Cl. 52/204.6

(57) ABSTRACT

Double-glazed thermoinsulated external wall particularly for windows or the facade of buildings, constituted by an outer pane and an inner pane, parallel to one another and defining a space, characterized in that it comprises a forced air circulation unit in said space.

### TECHNICAL FIELD

The following invention regards a double-glazed thermoinsulated external wall.

### BACKGROUND ART

The manufacture of window fittings and building facades frequently uses walls constituted by two panes of glass, mounted parallel to one another and brought together on a frame and creating a space filled with air between them; such walls are commonly known as “double glazing”.

The use of such walls, introduced primarily to obtain insulation, both thermal and acoustic, between the interior and exterior environments, often prove somewhat unefficient, especially in applications in which the surface of the glass is relatively high (for example, in the case of entire facades made of glass).

In particular, during the winter, when the interior is artificially heated, double-glazed walls of the known type cause excessive heat dispersion towards the exterior, thus entailing high energy consumption associated to the so-called “cold wall” effect, that can be experienced in the vicinity of the windows, which can be bothersome when the temperature outside is very low (effect often accompanied by unpleasant condensation deposits of the water vapour present inside).

During the summer, interiors are usually kept cool by air conditioning systems, at a temperature often decidedly lower than that outside: it is therefore necessary to prevent the often considerable amounts of energy required to maintain the interior at an optimal temperature for the people inside from being wasted due to diffusion of solar heat through the windows or building facades in glass.

### DISCLOSURE OF INVENTION

The aim of the present invention is to resolve the above-mentioned drawbacks by devising a double-glazed thermoinsulated external wall that consents minimal dispersion of the energy required to maintain an optimal temperature in the interior environment.

With regards to this aim, one purpose of the present finding is to create a double-glazed thermoinsulated wall that makes it possible to eliminate the bothersome “cold wall” effect during the winter period.

A further aim of the invention is to devise a double-glazed thermoinsulated wall that constitutes an effective barrier against the heat released by the “double glazing” and simple glazing, with a double security layer, in the case that the glass is darkened or partially refelective, in order to prevent or mitigate the effect caused by the penetration of the sun's rays, which creates discomfort for the people inside and an immediate rise in temperature.

A further aim of the invention is to provide a simple structure, of relatively easy practical implementation that is safe to use and efficient and has a relatively low price.

The above-mentioned objectives can be achieved by the present double-glazed thermoinsulated external wall particularly for windows or building facades, constituted by an external pane and an internal pane positioned parallel to one another and creating a space between them, characterized in that it comprises a forced air circulation unit in said space.

### BRIEF DESCRIPTION OF DRAWINGS

Description details of the invention shall be further evident in the illustrations of a preferred type of double-glazed thermoinsulated wall according to the invention, given as an example, in the guideline drawings attached and wherein:

FIG. 1 illustrates an exploded prospective view of the thermoinsulated wall in object;

FIG. 2 illustrates a detailed exploded prospective view of the air circulation unit of the same wall;

FIG. 3 illustrates a constructive detailed prespective view of the unit;

FIG. 4 illustrates a lateral section elevation view of further constructive details of the unit;

FIG. 5 illustrates a prospective view of a first constructive variant of the thermoinsulated wall according to the invention;

FIG. 6 illustrates an exploded prospective view of said first variant;

FIG. 7 illustrates a detailed exploded prospective view of a second variant of the thermisolated wall according to the invention;

FIG. 8 illustrates a lateral elevation view of a third variant of the thermoisolated wall according to the invention;

### MODES FOR CARRYING OUT THE INVENTION

With reference to such figures, 1 refers to a double-glazed thermoinsulated external wall according to the invention, particularly for windows and building facades.

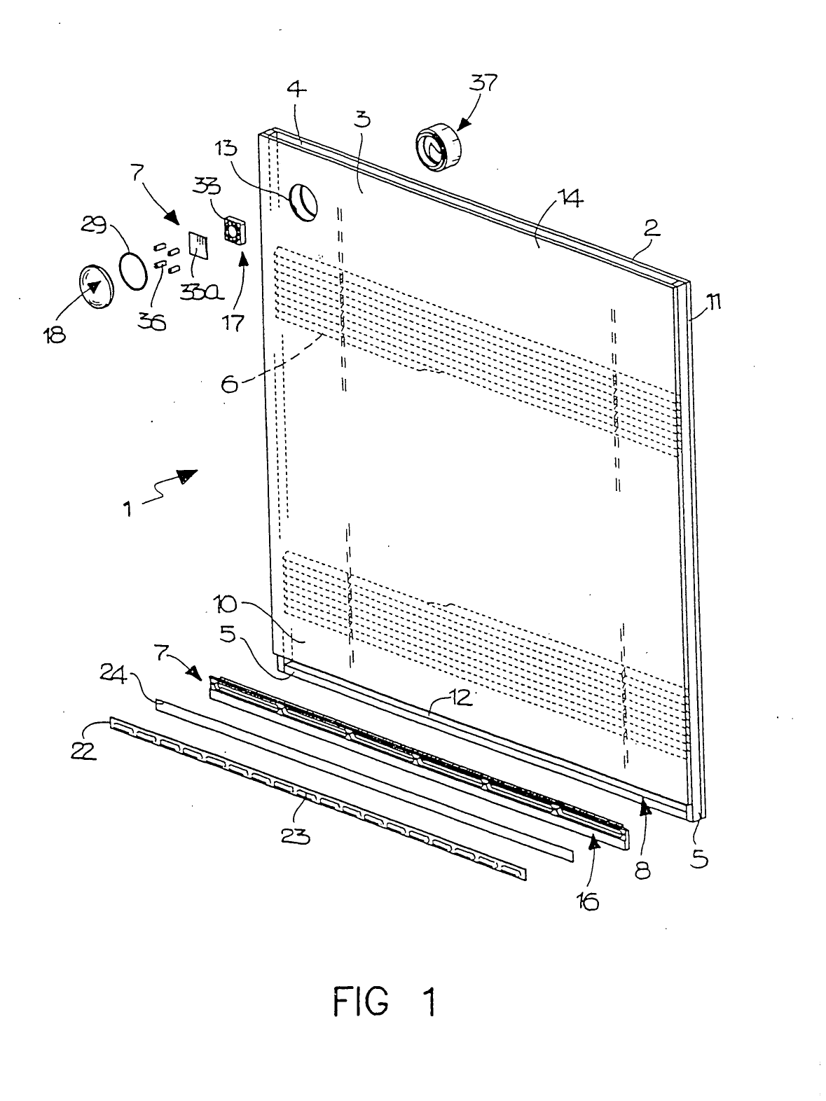

The wall 1 is constituted, as per the state of the art (FIG. 1), by an external pane 2 and an internal pane 3, parallel to one another and preferably manufactured in glass, for example smoked glass, thus defining a space 4 between them that is substantially laminar: the wall 1 can be integrated for example inside a window frame, or can be mounted in such a way as to constitute a glass building wall, thus insulating the outside environment from the internal one, usually subject to climatisation. The wall is peripherically fitted with metal perimetral spacers 5, of the type containing substances for the absorption of humidity from the air; as known, inside the space it is possible to introduce a dimming element, for example a shutter 6, that can be commanded from the interior environment, in order to prevent the penetration of sunrays and the heat they bring from outside. According to the invention, the wall includes a forced air circulation unit 7 inside the space 4, in order to take the air inside the space to the same temperature that is recorded in the climatised interior environment, thus reducing heat dispersion to a minimum.

The thermoinsulated wall comprises an air intake aperture 8 in the space 4 communicating with the outside environment, and an air outlet aperture 9 leading to the external environment: preferably, the intake aperture 8 is situated at the base 10 of the internal pane 3, whereas the outlet aperture 9 is created at the top 11 of the external pane 2.

The intake aperture 8 is constituted by a horizontally elongated slit 12 made for example by a cut and the removal of the lower end part of the internal pane 3. The outlet aperture 9, on the other hand, consists in an inner circular hole 13, made at the top 14 of the internal pane 3 and in an external circular hole 15 made at the top 11 of the external pane 2: the circular holes 13 and 15 are coaxial to one another and have substantially the same diameter.

The forced circulation unit 7 comprises an air intake opening 16 mounted on the slit 12 and an air exhaust device 17 fixed on a support 18, fixed by the inner circular hole 13.

The opening 16 (FIG. 3) is constituted by a horizontal bar 19 fixed to the base 10 of the internal pane 3, and presents a number of slots 20 substantially aligned horizontally and connected with the space 4. The bar 19 is fitted at the front with clamping holes 21 for an elongated covering element 22, interested by a series of slot holes 23 of the air inflow taken from the interior environment; the covering element 22 is fixed to the opening 16 with the interposition of a strip of material 24 for filtering the intake air. On the upper edge of the bar there is a longitudninal groove 25 for engaging the base 10 of the interior pane 3.

The support 18 for the air exhaust device 17 comprises a disk 26 engaged inside the inner circular hole 13 in correspondence with a concentric discoidal portion 27 with a smaller diameter. The discoidal portion 27 is interested laterally by a ring-shaped throat 28, by the mounting of a ring gasket in synthetic material such as rubber: the gasket 29 makes it possible to create a substantial seal between the internal environment (climatised) and the space 4.

On the lateral surface of the disk 26 there is also a radial notch 30, whereas on the frontal surface 31 of the disk facing the space 4, there are four threaded holes 32, substantially arranged according to the apexes of a square.

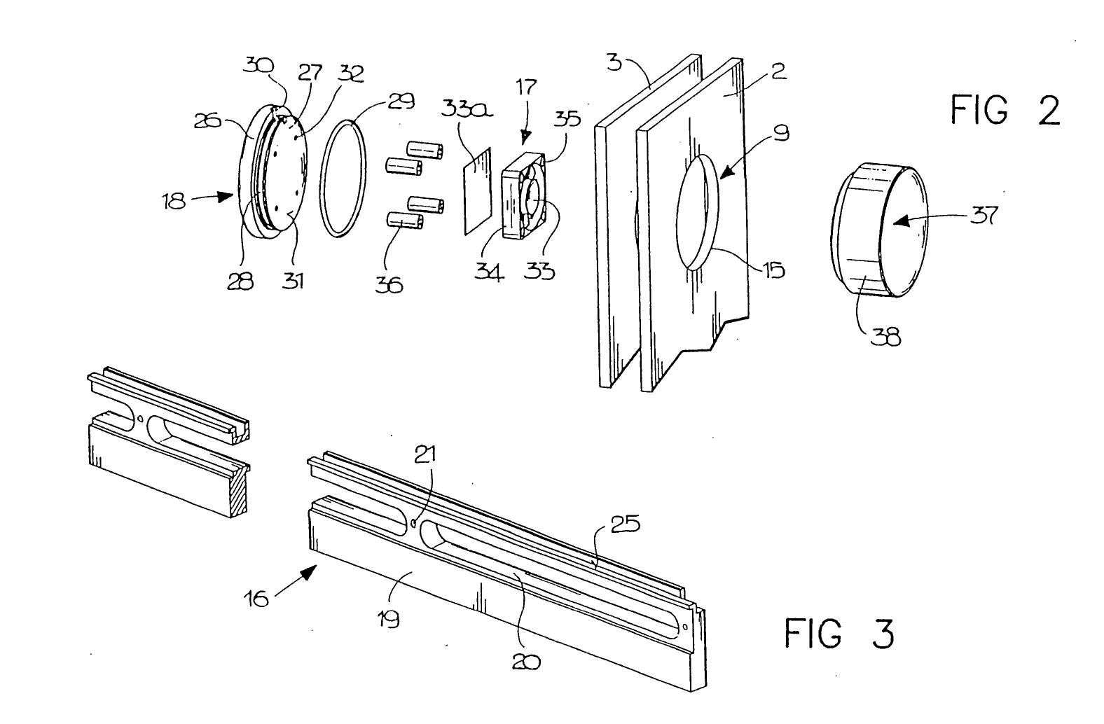

The air exhaust device 17 (FIG. 2) is constituted by a fan 33 arranged according to a substantially horizontal axis and orthogonal to panes 2 and 3, supplied electrically by means of, for example, cables passing through the radial notch 30 made on the disk 26; the fan 33 is mounted, together with a filter 33a, on a quadrangular frame 34 interested, in correspondence with the apexes, by passing holes 35 for the clamping with screws tightened in the respective threaded holes 32 of the disk 26. The screws are threaded loose in the respective spacer bushings 36, which are substantially tubular, for positioning the fan 33 in correspondence of the outer circular hole 15, in such a way as to expel the air circulating inside the space 4.

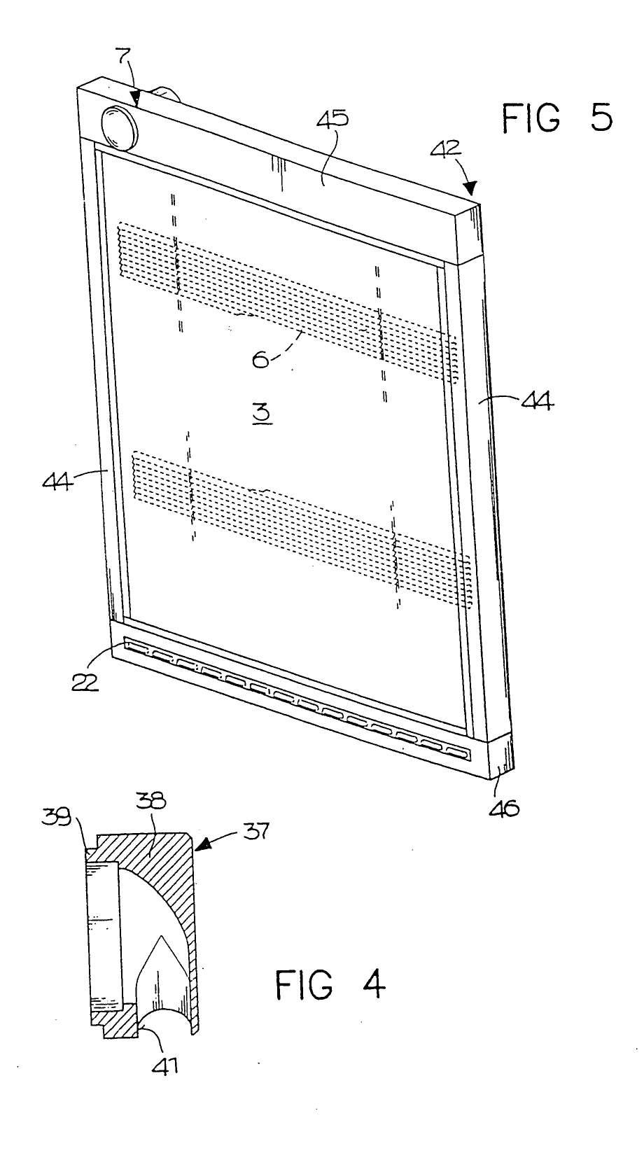

The forced circulation unit 7 also comprises a cowling 37 (FIG. 4), fixed externally in correspondence with the outer circular hole 15, in order to permit the outflow of air from the space 4. The cowling 37 is constituted by a tubular portion 38, closed at the base, presenting in correspondence with the other base an offset 39 for centring on the outer circular hole 15. The cowling 37 is fixed, for example, by a pair of screws engaged in their respective diametrically opposite threaded holes 40 realised with axes parallel to that of the tubular portion 38, in correspondence with the offset 39.

The cowling 37 presents, on the lateral surface, a substantially transversal cleft 41 pointing downwards, defining an expulsion pipe for the air from the space 4: the cleft 41 can be fitted with an external grate in order to prevent dirt or insects entering the space.

The functioning of the thermoinsulated wall according to the invention is as follows: when the fan 33 is activated by the users, the air from the interior environment, which is at a preset temperature, penetrates through the opening 16, thus circulating inside the space 4, which when fully functional, takes it to the same temperature as the interior environment. Advantageously, air circulation can be managed by the aid of a thermostat, that starts up and stops the fan 33 according to the temperature of the air inside the space 4.

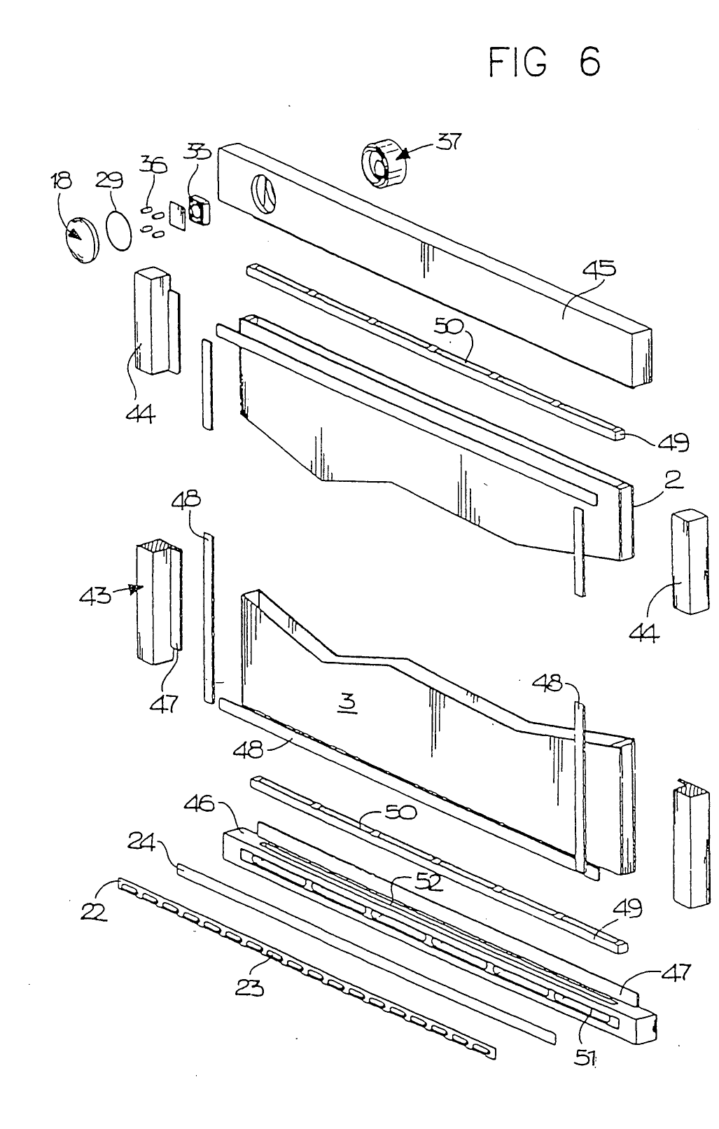

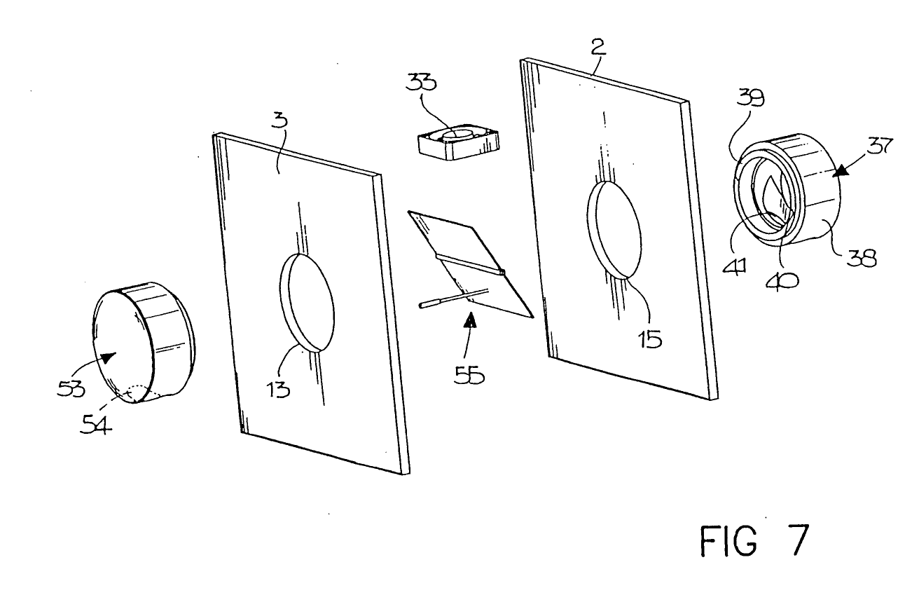

According to a first variant of the thermoinsulated wall (FIGS. 5, 6), the inner pane 3 and the outer pane 2 are mounted on a framework 42 constituted by a perimetral frame 43, comprising two lateral uprights 44, one upper transverse member 45 and one lower transverse member 46.

The transverse members 45 and 46 and the uprights 44 present respectively longitudinal ribs 47 for contact with the outer pane 2, there being strips 48 applied perimetrally to the inner pane 3 for the clamping of the frame 43. The upper 45 and lower 46 tranverses member are associated to the respective small traverse members 49 mounted in such a way as to form the substantial upper and lower closure of the space 4, being interested by a number of longitudinal passing slots 50 in order to consent air flow.

The lower transverse member 46 has a subtantially elongated parallelipiped shape that is hollow, having slotted orifices 51 on the front, which are substantially horizontally aligned and at the top has a rut 52 communicating with the space 4. The covering element 22 and the strip of filtering material 24 are mounted on the slotted orifices.

The upper transverse member 45 has a substantially parallelipiped shape and is hollow and open on the lower side: it is fixed on the uprights 44 and presents, at one end, the internal 13 and external 15 circular holes for the assembly of the air exhaust device 17. Between the inner pane 3 and the outer pane 2, inside the space 4, it is possible to introduce a dimming element such as a shutter 6, that can be manoeuvred by the users, as the effect of air circulation can also be perceived with darkened windows or those covered with a reflective coating, which entail a significant rise in temperature and thus causes discomfort to the people inside.

A second variant of the thermoinsulated wall according to the invention (FIG. 7) includes the fixing of a second cowling 53 in correspondence with the inner circular hole 13, of a tubular conformation closed on one side and fitted with a transversal mouth 54, pointing downwards, for the recirculation of the air in the internal environment.

According to this variant, the fan 33 is fixed above the inner 13 and outer 15 circular holes, with a substantially vertical axis; selective occlusion means 55 at the user's discretion are also foreseen, of the outer circular hole 15 and the inner circular hole 13, which consent the outflow of the air circulating in the space 4 respectively in the interior and exterior environments.

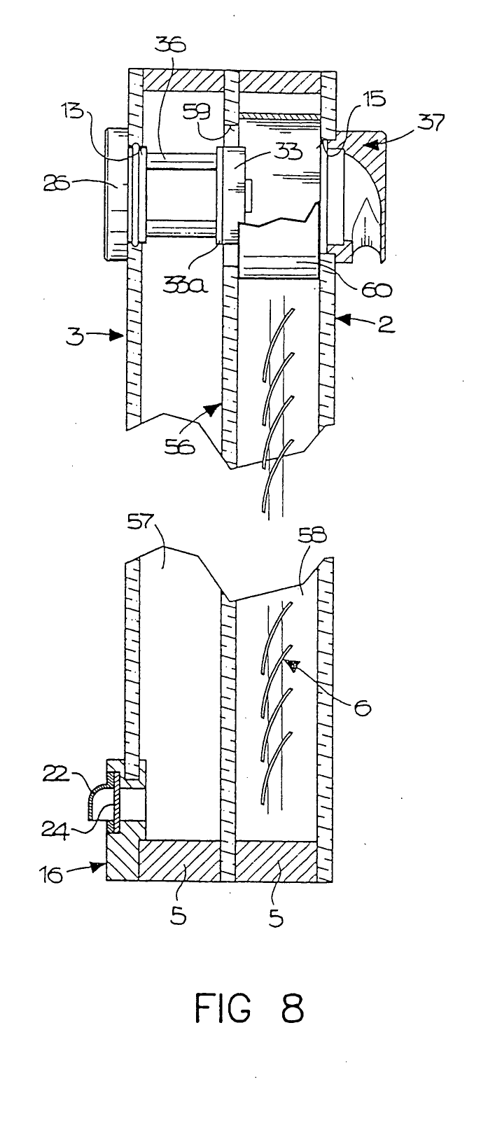

In a third variant of the thermoinsulated wall according to the invention (FIG. 8), it is possible to introduce, between the outer 2 and inner 3 panes an intermediate pane 56, parallel to them, in order to subdivide the space 4 into an inner chamber 57 where air circulates by means of the circulation unit 7, and an external chamber 58, for the introduction of the dimming element 6 such as a shutter or curtain.

The intermediate pane 56 presents above, an intermediate circular hole 59, coaxial to the inner circular hole 13 and the outer circular hole 15; the external chamber 58 is substantially sealed, being isolated from both the interior environment and the exterior environment, by the presence of a sleeve 60 fixed artight between the intermediate wall 56 and the external pane 2 coaxially to the intermediate circular hole 59 and to the outer circular hole 15. The sleeve 60, having an internal diameter superior to that of the intermediate 59 and outer 15 holes, connects the inner chamber 57 to the exterior environment, thus allowing the air to flow out thanks to the fan 33 which, with suitable dimensioning of the spacer bushings 36 is localised substantially in correspondence with the intermediate circular hole 59.

The subdivision of the space 4 with the intermediate pane 56 and the consequential realisation of an external chamber 58 sealed with a shutter-type dimming element 6, favours a more correct and easy circulation of air between the external and internal panes 2 and 3 and its outflow into the exterior environment; it should be noted that the intermediate pane 56 can be included even if the thermoinsulated wall is mounted on the framework 42 with the upper transverse member 45.

The circulation in the space 4 of air from the internal environment, combined with the darkened glass and the other dimming elements for example shutter or curtain types, guarantees efficient thermal insulation between the interior environment and exterior environment, thus minimising heat dispersion during the winter period and providing a barrier against external heat during the summer period.

It is therefore evident how the invention achieves the proposed aims.

The invention thus conceived may be subject to alterations and variants, all of which are part of the ambit of the invention.

Materials adopted for the actual realization of the invention, as well as their shapes and sizes, can be various, depending on the requirements. Where technical features mentioned in any claim are followed by reference signs, those reference signs have been included for the sole purpose of increasing the intelligibility of the claims and accordingly, such reference signs do not have any limiting effect on the scope of each element identified by way of example by such reference signs.

1. Double-glazed thermoinsulated external wall, particularly for windows or the facade of buildings, constituted by an outer pane and an inner pane, parallel to one another and defining a space, wherein it comprises a forced air circulation unit in said space; an air intake aperture in said space communicating with the interior environment and positioned at the base of said internal pane; and an air outlet aperture leading to the outside and positioned at the top of said outer pane, said intake aperture being constituted at least by a horizontally elongated slit and said outlet aperture being constituted at least by an outer circular hole made at the top of said outer pane.

2. The thermoinsulated wall according to claim 1, wherein said outlet aperture comprises an inner circular holy made at the top of said inner pane.

3. The thermoinsulated wall according to claim 1, wherein said circular holes are coaxial and have substantially the same diameter.

4. The thermoinsulated wall according to claim 1, wherein said forced circulation unit comprises an opening mounted on said slit and an air exhaust device, mounted on a respective support, fixed in correspondence with the inner circular hole.

5). The thermoinsulated wall according to claim 1, wherein said opening is constituted by a horizontal bar mounted at the base of the said inner pane and presenting a number of holes substantially horizontally aligned and communicating with said space.

6. The thermoinsulated wall according to claim 1, wherein said support comprises a disk engaged within said inner circular hole with the interposition of a ring gasket, having the surface facing said space interested by four blind threaded holes, substantially arranged according to the apexes of a square.

7. The thermoinsulated wall according to claim 1, wherein said exhaust device is constituted by a fan with a substantially horizontal axis and powered by an electrical supply, fitted with a filter and a frame with four passing holes for clamping, with screws, respectively in said threaded holes of said disk, said screws being threaded loose into the respective bushing spacers in order to position said fan in correspondence with said outer circular hole, for the expulsion of the air circulating inside said space.

8). The thermoinsulated wall according to claim 1, wherein said forced circulation unit, comprises a cowling, fixed externally in said external circular hole and interested, on the lateral surface, by a transversal cleft for the expulsion of air from said space.

9. The thermoinsulated wall according to claim 1, wherein it comprises a dimming element such as a shutter type introduced within said space.

10. The thermoinsulated wall according to claim 1, wherein said inner pane and outer pane are created in darkened glass with partial light permeability.

11. The thermoinsulated wall according to claim 1, wherein it comprises a framework constituted by a perimetral frame, associated to two small cross members with substantial upper and lower closing of said space and fitted with a respective number of passing longitudinal slots in order to permit the flow of the air, said frame comprising a substantially hollow upper cross member communicating with said space, interested by said inner and outer circular holes for the fixing of said disk and said cowling respectively.

12. The thermoinsulated wall according to claim 1, wherein it comprises a second cowling fixed on to said inner circular hole and fitted with a transverse mouth for the recirculation of air in the interior environment, said fan being fixed above with a substantially vertical axis and with means of selective occlusion of said external circular hole and said internal circular hole being included in order to permit the outflow of the air circulating in said space into the internal and external environment respectively.

13. The thermoinsulated wall according to claim 1, wherein it comprises an intermediate pane parallel to said internal and external panes to subdivide said space into an internal chamber for air circulation and an external chamber for the introduction of said shutter-type dimming element.

14. The thermoinsulated wall according to claim 1, wherein said external chamber is substantially sealed, said intermediate pane having an intermediate circular hole coaxial to said internal and external circular holes, said inner air circulation chamber being in communication with the exterior environment by means of a sleeve fixed airtight between said intermediate pane and said external pane coaxially to said intermediate hole and said external hole.
